(19) United States
(12) Patent Application Publication
(10) Pub. No.: US 2001/0055274 A1
(43) Pub. Date: Dec. 27, 2001

(54) System and method for flow mirroring in a network switch

(76) Inventors: Doug Hegge, Vancouver, WA (US); Charles C. Lindsay, Ashland, MA (US); Theodore Langston Ross, Littleton, MA (US); Krishna Narayanaswamy, Acton, MA (US); Barry A. Spinney, Wayland, MA (US)

Correspondence Address: Stephen Y. Chow, Perkins, Smith & Cohen, LLP, One Beacon Street, Boston, MA, 02108, US

(21) Appl. No.: 09/791,517

(22) Filed: Feb. 22, 2001

Related U.S. Application Data
(60) Provisional application No. 60/184,054, filed on Feb. 22, 2000.

(51) Int. Cl. H04L 12/26

(52) U.S. Cl. 370/229; 370/423

(57) ABSTRACT

A network switch has a plurality of mirror ports to which data is copied for purposes such as networking monitoring. Data flows are identified and copied to an appropriate mirror port in response to the type of flow, a mirroring policy set up by a network administrator, and a distribution mechanism. A monitoring device attached to each mirror port is able to monitor specific types of traffic. Because the data flows are distributed among a plurality of mirror ports and monitoring devices, the ports and devices are less likely to overflow and therefore are more likely to be able handle the copied data without dropping data packets. The mirror ports are collected into groups of such ports. A given port may only be a member of a single group at one time. The mirroring policy must identify the group to which a particular type of flow is copied.

### CROSS-REFERENCE TO RELATED APPLICATIONS

This application claims priority of U.S. provisional applications Ser. No. 60/184,054 entitled, “System and Method for Flow Mirroring in a Network Switch” filed Feb. 22, 2000 by the present applicants.

### FIELD OF THE INVENTION

This invention relates generally to computer networks and more particularly to mirroring data flows in a network switch.

### BACKGROUND OF THE INVENTION

In a typical L2/L3 (OSI Layers 2 or 3) network switch, a received packet is examined to determine its destination, and an egress port is selected to send the packet. Policies may be defined by the administrator to control this selection. Some network switches also allow an administrator to direct that packets flowing through specific ports be additionally copied to an additional port called a Switch Port Analyzer port, or “SPAN” port.

Given a SPAN port on an L2/L3 switch, one can direct all of the traffic received and/or transmitted through a given set of ports be copied to the SPAN port for observation by a monitoring device. One application of this port arrangement is that application of monitoring network traffic (sometimes called “sniffing”) in order to debug problems. Another application is that of monitoring the network to detect anomalous and potentially inimical traffic. This is sometimes called network intrusion detection. While some network attacks can be identified from a single packet, other require the receipt and analysis of a protracted sequence of packets.

If the aggregate flow of traffic from the “regular” ports exceeds the bandwidth of the span port, some packets will be dropped inevitably from the monitored traffic. Even if the capacity of the span port is sufficient to carry all of this copied traffic, the monitoring device itself may not have the capacity to process all of the packets it receives, and it will drop some.

It remains desirable to increase the ability of a network switch to copy data traffic to a plurality of ports.

It is an object of the present invention to provide a method and apparatus to increase copied data traffic to an additional egress port in a network switch with a reduction in dropped packets.

### SUMMARY OF THE INVENTION

These problems of copying data traffic are solved by the present invention of flow mirroring in a network switch. Flow identification and switching are disclosed in U.S. patent application Ser. No. 09/285,617, filed Apr. 3, 1999 and entitled, “Application-Level Data Communication Switching System and Process for Automatic Detection of and Quality of Service Adjustment for Multimedia Streaming Applications” and is incorporated herein by reference. A “flow” is a sequence of network messages that occur as a result of a requested process such as reading a file, sending an e-mail message, browsing a web site, initiating a file transfer, making a database query, etc., and routes the packet accordingly, thereby establishing a “virtual connection” at Layer 4 and above. The invention is further adapted for “application flow switching,” wherein the invention classifies received frames into flows based not only on the Layer 2 MAC or Layer 3 network address, but also on the information contained in higher layers, even up to “Application” Layer 7 of the OSI model. Thus, the invention can differentiate between flows that result from web browsing and flows that result from a file transfer or database query, even though both may use the same Layer 3 protocol.

A network switch has a plurality of mirror ports to which data is copied for purposes such as networking monitoring. Data flows are identified and copied to an appropriate mirror port in response to the type of flow, a mirroring policy set up by a network administrator, and a distribution mechanism. At each mirror port, a monitoring device monitors specific types of traffic. Because the data flows are distributed among a plurality of mirror ports and monitoring devices, the ports and devices are less likely to overflow and therefore are more likely to be able handle the copied data without dropping data packets.

The mirror ports are collected into groups of such ports. A given port may only be a member of a single group at one time. The mirroring policy identifies the group to which a particular type of flow is copied.

The present invention together with the above and other advantages may best be understood from the following detailed description of the embodiments of the invention illustrated in the drawings, wherein:

### BRIEF DESCRIPTION OF THE DRAWINGS

FIG. 1 is a block diagram of a mirroring network switch according to principles of the invention.

### DETAILED DESCRIPTION OF PREFERRED EMBODIMENTS

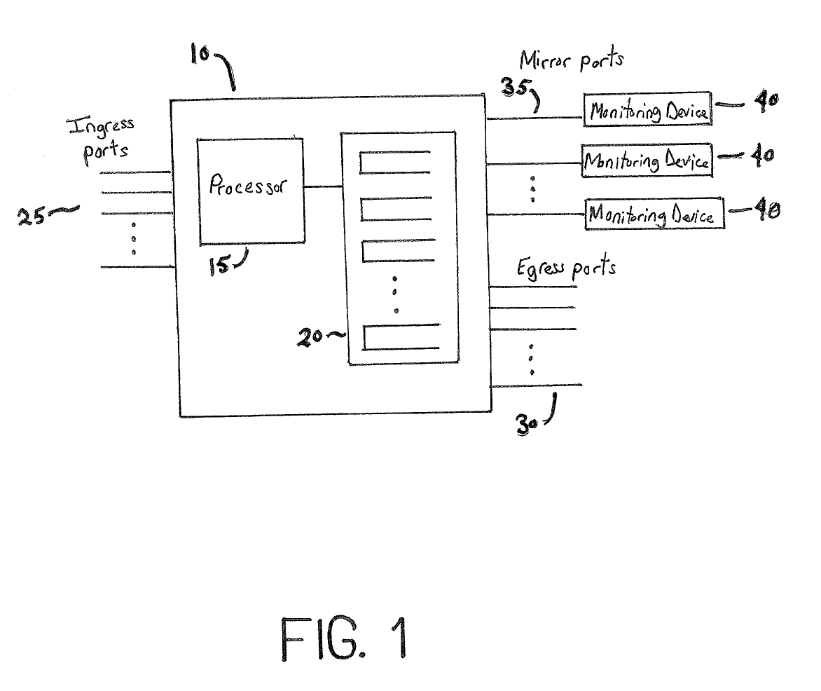

FIG. 1 is a block diagram of a network switch 10 according to principles of the invention. The network switch 10 has a processor 15, a plurality of queues 20, a plurality of ingress ports 25, a plurality of egress ports 30, and a plurality of mirror ports 35. A network monitoring device 40 is attached to each mirror port.

In operation, the plurality of ingress ports 25 brings data traffic in to the switch 10 where the processor 15 identifies data flows, i.e., types of traffic, and switches packets to appropriate queues 20 according to flow and destination. The data packets of the various data flows are transmitted to destinations through the plurality of egress ports 30. The switch uses information at various network layers of the OSI model to distinguish and identify data flows. Once detected, packets from the data flows are queued to the appropriate egress ports. The data may also be copied to the mirror ports. The switch, as shown is FIG. 1, is presented here with predefined ingress, egress and mirror ports for illustration purposes. Over the course of switch operation, a port may be an ingress, egress or mirror port depending on switch configuration and the particular data flow being handled at any one time. A port may, for example, simultaneously be an ingress, egress and mirror port when the port connects the switch to an Intrusion Detection system (IDS). In that case, data traffic through the switch to other ports is copied to the mirror port for monitoring by the IDS, and the IDS itself communicates to other devices attached to the switch, for example a console, using the mirror port.

In flow identification and switching, the switch automatically provides the appropriate quality of service (such as guaranteed bandwidth) for multimedia streaming applications such as video conferencing under the International Telecommunication Union (ITU) H.323 standard. The switch examines and interprets the H.225 and H.245 setup messages to determine the characteristics of the subsequent G.7xx and H.26x audio and video streams, and automatically sets up entries in a flow table defining the quality of service, applying the appropriate priorities to these streams.

The switch connects networks at the application layer, and uses information above Layer 3 of the OSI model. The switch performs “flow switching” or connection, wherein, based on the information in a received data packet at Layer 4 and above, the switch identifies a flow and routes the packet accordingly, thereby establishing a “virtual connection” at Layer 4 and above. The switch also performs “application flow switching,” wherein the switch classifies received frames into flows based not only on the Layer 2 MAC or Layer 3 network address, but also on the information contained in higher layers, even up to Application Layer 7 of the OSI model. Thus, the switch can differentiate between flows that result from web browsing and flows that result from a file transfer or database query, even though both may use the same Layer 3 protocol. 17 In the preferred embodiment of the invention, differentiation between flows is accomplished using a combination of hardware and software optimized for speed or for flexibility at their respective functions. Thus, dedicated “silicon” or gates at the chip level are employed to extract rapidly information from the data link headers corresponding to the relatively few data link protocols such as Ethernet, Fast Ethernet, and Frame Relay, and from the network headers of the relatively few network protocols such as Internet (IPv4, IPX, IPv6), SNA, and DECNet, while application protocols in up to 128 bytes of header information are recognized by fast pattern matching software. By looking at the application header, the switch can make decisions about quality of service to be applied to a particular flow or stream of packets (such as e-mail, which is priority-based, as opposed to multimedia, which is bandwidth-guarantee-based) and can keep all connections while backing off of all applications fairly.

By using internally standard or “canonical” headers including data link and network information deduced or inferred at the port interfaces, and comparing hashed versions of the canonical headers to identify the packets to flows with common flow rules, the switch efficiently establishes a virtual connection between the appropriate ports associated with a given flow. This feature allows the system to be “frame or cell”-independent and to route ATM traffic as not heretofore done.

The “intelligence” of the system in tracking packets according to the flow allows “cut through” flow, that is, the output from a port of portions of a data packet stream even as portions of the data packet stream are entering a port. Many other intelligent functions are possible because of the flexible and scalable architecture of the system using interface ASICs (application-specific integrated circuits) to “canonicalize” Layer 2 and 3 header information, a high speed bus, a queue manager ASIC which rapidly implements queuing decisions of a fast relay engine ASIC, and a background engine ASIC that monitors the flow connections.

The plurality of mirror ports (also called CarbonCopy ports or Cc ports) are collected into groups referred to as CarbonCopyGroups or Ccgroups. A mirror port may be a member of only one Ccgroup at one time.

The network administrator can establish policies to copy all data to the mirror ports or to copy only selected data flows. For example, the network administrator may want to see only the e-mail traffic between a specific server and a specific user to debug a particular problem.

Where there are a plurality of copied data flows, they are distributed across the plurality of mirror ports enabling the ports to better handle the volume of traffic. By attaching a monitoring device to each of the plurality of mirror ports, the data flows are also distributed across monitoring devices. All packets belonging to a single flow or context (both directions of traffic for bi-directional sessions such as TCP) are directed to the same mirror port so that the monitoring devices can maintain complete contexts for the data flow. In addition, packets from a data flow may be copied concurrently to mirror ports of two different Ccgroups. This is done when different types of monitoring devices are used to examine a data flow. For example, a first monitoring device may be an intrusion detection device and a second device may be a network debugging device.

In the present embodiment of the invention, a simple round-robin method is used to distribute the data flows among the mirror ports. When a flow is identified by the switch, the switch determines from the mirroring policy set by the network administrator, which group of mirror ports is to be used for the identified flow. Then the switch selects a mirror port from the group for the identified flow using the simple round-robin method.

In a first alternative embodiment of the invention, the flows are distributed by flow weight. Data traffic for an application can often be characterized as imposing a specific processing load on a monitoring device. This weight characterization is used to balance flows across a Ccgroup so that no monitoring device is more heavily loaded than any other monitoring device. The flow may additionally be directed, within the Ccgroup, to a port having a particular capability.

In a second alternative embodiment of the invention, the flows are distributed by flow count. Flows can be evenly distributed across the CcGroup purely by flow count. As the number of flows allocated to a given port are incremented or decremented (as the switch detects that a flow has terminated), a port within the group becomes less or more likely to be selected for the next flow.

In a third alternative embodiment of the invention, flows are distributed by traffic level (either in packets or bytes and possibly weighted by application type). The allocation of a next flow to a port within a group can be determined based on the average relative traffic levels seen in the individual ports, relative to their defined capacity. This is especially useful if some ports are operating at a different speed than others.

In a fourth alternative embodiment of the invention, an individual monitoring device can indicate to the switch via a communication protocol when it is appropriate to direct additional flows to the monitoring device.

The communication is maintained between the monitoring devices and the switch to control the distribution of monitored flow. This feedback process is primarily of interest when the monitoring device is autonomously inspecting network traffic for anomalous, and possibly inimical behavior. This protocol can also be used to detect failures amongst the monitoring devices to allow redistribution of mirrored flows among the surviving monitoring devices. A monitoring device can also indicate when a flow need no longer be monitored. Finally, the communication from the monitoring device to the switch enables the monitoring device to dynamically affect the admission and quality of service policies used by the switch, both for existing flows and flows to be established.

In a fifth alternative embodiment of the invention, a number of packets at the beginning of a flow can be copied to a single monitoring device for detecting port scans and flooding attacks. The number of packets may be for example 3 or 4 packets. This is useful for detecting intrusion because network hackers typically scan a victim network before an attack looking for addressable and vulnerable hosts. This process is known as “host scanning” or “port scanning.” In a different kind of network attack, known as “denial of service” or DOS attack, the hacker floods a host or sub-network of hosts with a large number of service requests consuming all of the network resources. Both host scanning and a denial of service attack can be identified by an intrusion detection system from the first three or four packets of a data flow.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A process for flow mirroring in an information network switch comprising:
a) receiving information at an ingress port;
b) determining whether said information is a part of a particular flow of information that is a member of a preselected group of flows of information; and
c) copying said information and forwarding one of the copies to a mirror port if said information is determined to be part of said particular flow.

2. A process for flow mirroring in a data packet network switch comprising:
a) receiving a data packet at an ingress port;
b) determining whether said data packet is a part of a preselected particular flow of data packets;
a) copying said data packet and forwarding one of the copies to a mirror port if said data packet is determined to be part of said particular flow.

3. The process of claim 2 wherein, if said data packet is not determined to be part of said first particular flow, step (b) further comprises determining whether said data packet is part of a second particular flow of data packets and step (c) further comprises copying said data packet and forwarding one of the copies to a second mirror port if said data packet is determined to be part of said second particular flow.

4. The process of claim 2 wherein said mirror port is one of a predefined group of several mirror ports.

5. The process of claim 3 wherein said second mirror port is one of a predefined group of several mirror ports that do not include any mirror port to which a data packet determined to be part of said first particular flow would be forwarded according to step (c).

6. The process of claim 2 wherein said particular flow is selected according to the destination of said flow.

7. The process of claim 2 wherein said particular flow is selected according to the application of said flow.

8. The process of claim 2 wherein said particular flow is selected during the normal switching operation of said data packet switch.

9. The process of claim 2 wherein said predefined group of mirror ports is selected during the normal switching operation of said data packet switch.

10. The process of claim 2 wherein all packets part of said flow are forwarded to said mirror port.

11. The process of claim 2 wherein all packets part of a context are forwarded to said mirror port.

12. The process of claim 4 wherein all packets part of said flow are forwarded to one mirror port among said predefined group of mirror ports, said one mirror port selected for said flow using a round-robin procedure of selection among said predefined group of ports for different flows received by said data packet switch.

13. The process of claim 4 wherein all packets part of said flow are forwarded to one mirror port among said predefined group of mirror ports, said one mirror port selected for said flow using a procedure of selection among said predefined group of ports for different flows received by said data packet switch in which flows belonging to a particular application receive priority in a given interval over flows belonging to another application.

14. The process of claim 13 wherein flows belonging to a particular application receive said priority based on the processing load presented by said flows at said mirror port.

15. The process of claim 4 wherein all packets part of said flow are forwarded to a particular mirror port among said predefined group of mirror ports where special processing is provided for said flow at said particular mirror port.

16. The process of claim 4 wherein all packets part of said flow are forwarded to one mirror port among said predefined group of mirror ports, said one mirror port selected for said flow using a procedure of selection among said predefined group of ports for different flows received by said data packet switch assigning an equal number of active flows at each mirror port of said group.

17. The process of claim 4 wherein all packets part of said flow are forwarded to one mirror port among said predefined group of mirror ports, said one mirror port selected for said flow using a procedure of selection among said predefined group of ports for different flows received by said data packet switch based on average relative traffic levels seen at individual ones of said predefined group of mirror ports.

18. The process of claim 4 wherein all packets part of said flow are forwarded to one mirror port among said predefined group of mirror ports, said one mirror port selected for said flow using a procedure of selection among said predefined group of ports for different flows received by said data packet switch wherein individual monitoring devices at each of said predefined group of mirror ports signal to said data packet switch when it is appropriate to send additional flows to their respective ports.

19. The process of claim 18 comprising the further step of detecting failures among said monitoring devices.

20. The process of claim 18 comprising the further step by one of said monitoring devices to signal to said data packet switch that a flow need no longer be monitored.

21. The process of claim 18 comprising the further step of dynamically establishing at said data packet switch in response to information received from said monitoring devices admission and quality of service policies used by said data packet switch for existing flows and flows to be established.

22. A network switch, comprising:
at least one ingress port to receive data packets into the switch;
at least one egress port to transport data packets out of the switch;
a mirror port; and
a switch processor that routes said data packets on said at least one egress port, determines which of said received data packets are members of a group of at least one particular flow and to copy said member packets to said mirror port.

23. The network switch of claim 22 further comprising:
a plurality of mirror ports, said switch processor to copy packets belonging to said flow to at least one of said plurality of mirror ports.

24. The network switch of claim 22, further comprising:
a plurality of mirror ports, said switch processor to copy packets belonging to said flow to a plurality of said mirror ports.

25. The network switch of claim 22 further comprising a plurality of mirror ports, said plurality of mirror ports divided into a plurality of groups of mirror ports wherein said switch processor forwards packets to one of said plurality of groups of mirror ports.
